(19) United States
(12) Patent Application Publication
(10) Pub. No.: US 2005/0275256 A1
(43) Pub. Date: Dec. 15, 2005

(54) Seat cushion

(76) Inventor: Geoffrey Gordon Hilliard, Huntingdon (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/882,417

(22) Filed: Jun. 30, 2004

(30) Foreign Application Priority Data
Jun. 9, 2004 (EP) 1425992

(51) Int. Cl. A47C 31/00; B68G 5/00; A47C 16/00; A47C 20/02

(52) U.S. Cl. 297/219.1

(57) ABSTRACT

A seat cushion (10) comprising a resilient foam body (12) defining on one surface thereof (14) a recess (16) for containing liquid spills (e.g. urine from an incontinent person). The one surface (14) is configured to prevent ingress of contained liquid spills into the resilient foam body (12), and the recess (16) borders a first side (20) of the resilient foam body (12) and extends inwardly towards a second side (22) of the resilient foam body (12) which opposes the first side, with the depth of at least part of the recess (16) increasing with distance from the first side (20) of the resilient foam body (12).

The present invention relates to a seat cushion, particularly, but not exclusively, a seat cushion for use by an incontinent person.

The present applicant has pioneered seat cushions for chairs used in the healthcare environment. The seat cushions include a tray-like recess on one surface for containing liquid spills. Each cushion comprises a resilient foam body with the tray-like recess preformed in one surface of the body, and a waterproof covering laminated to the body to follow the contours of the tray-like recess. The seat cushion is designed so that liquid spills (e.g. urine from an incontinent individual sat on the seat cushion) are, as far as possible, prevented from penetrating into the seat cushion and chair surround, and also prevented from running off the seat cushion, even when the individual is no longer sat on the cushion. By encouraging the formation of a pool of liquid, there is little or no damage to the chair and the liquid can be readily mopped up to prepare the chair for subsequent use.

In U.S. Pat. No. 4,752,293 (Smith), there is disclosed a barrier cushion for incontinent patients, the barrier cushion having a drainage channel extending therethrough with a an inclined drainage plane situated a central front part of the cushion. Examples of cushioned bedpans known in the art are disclosed in DE 2707408 (Steil), GB 1151458 (Carli) and U.S. Pat. No. 3,084,348 (Parker).

The present applicant is seeking to improve upon the highly successful seat cushions it has pioneered to date.

In accordance with the present invention, there is provided a seat cushion comprising a resilient foam body defining on one surface thereof a recess for containing liquid spills, the one surface being configured to prevent ingress of contained liquid spills into the resilient foam body, characterised in that the recess borders a first side of the resilient foam body and extends inwardly towards a second side of the resilient foam body which opposes the first side, with the depth of at least part of the recess increasing with distance from the first side of the resilient foam body.

The present applicant has appreciated that such a cushion with a “tapering recess” may be comfortable to sit on for long periods. By positioning the first side of the resilient foam body towards the front of the chair, there is no pronounced ridge between the recess and the front of the chair for the user to contend with when sat in the chair. Thus, there is little or no pressure concentration on the back of the user's thighs when sat in the chair. The reduction or absence of such a pressure concentration may avoid restricting blood circulation, perhaps alleviating the risk of developing medical complications associated with restricted blood circulation, such as deep vein thrombosis.

The recess may have little or no depth at the first side of the resilient foam body. The depth of the recess may increase uniformly towards a region of maximum depth, and the maximum depth may be substantially adjacent the second side of the resilient foam body.

The seat cushion may further comprise a waterproof layer (e.g. Teflon®-coated, micro-fungi/bacteria-resistant fabric) bonded to the resilient foam body to prevent ingress of liquid spills through the said one surface. For example, the waterproof layer may be laminated to the resilient foam body. The present applicants have found that laminating a waterproof layer to a resilient foam body with a tapering recess may be easier than in the seat cushions with a tray-like recess. When laminating a waterproof layer to a resilient foam body, great care is required to ensure the waterproof layer follows the surface contours of the body without rucking or creasing, and this is particularly the case at the corners of a recess. The tapering recess may have fewer or less pronounced corners than the tray-like recess, and thus may be easier to cover without introducing rucks or creases.

The seat cushion may be of the type in which the one surface is continuous (i.e. free of apertures or other drainage channels). In this way, a discreet seat cushion may be provided, particularly if covered by a waterproof layer which blends in with fabrics used to cover other parts of the chair.

An embodiment of the invention will now be described by way of example by reference to the accompanying drawings in which:

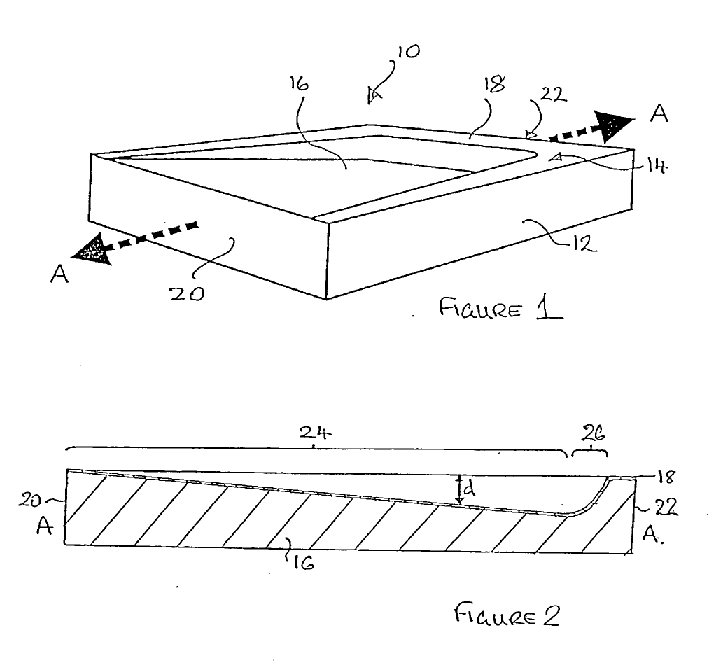

FIG. 1 is a perspective schematic view of a seat cushion embodying the present invention;

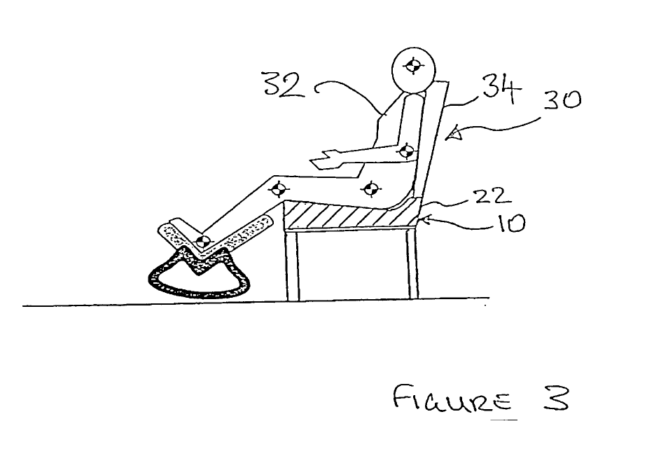

FIG. 2 is a cross section along the line A-A in FIG. 1.

FIG. 3 is a schematic illustration of the seat cushion of FIGS. 1 and 2 in a chair.

FIGS. 1 and 2 show a seat cushion (10) embodying the present invention. The seat cushion (10) comprises a resilient foam body (12) defining on upper surface (14) a recess (16) for containing liquid spills. The upper surface (14) is covered with a waterproof fabric (18) which is laminated to the resilient foam body (12) to follow its contours. The recess (16) borders and extends internally from the front side (20) of the resilient foam body (12), towards the opposing rear sides (22) of the resilient foam body (12). The depth “d” of a first part (24) of the recess (16) increases with distance from the front side (20) towards the rear side (22). Once a maximum depth is achieved, the depth of the second part (26) of the recess (16) decreases rapidly with increasing distance from the front side (20) towards the rear side (22). Thus, as can be seen from FIG. 2, the depth profile of recess (16) tapers and is generally wedge-like.

FIG. 3 shows schematically the use of the seat cushion (10) in a chair (30). The second part (26) of the recess (16) has to be close enough to the rear side (22) to prevent the user (32) from over compressing that section of the resilient foam body (16) which prevents liquid spills from escaping past the back (34) of the chair (30).

1. A seat cushion for an incontinent individual, comprising a resilient foam body defining on one surface thereof a pre-formed recess configured to contain urine from an incontinent individual when sat on the seat cushion and prevent urine running off the one surface when the incontinent individual is no longer sat on the seat cushion, the one surface being continuous to prevent passage of urine through the foam body and configured to prevent ingress of contained urine into the resilient foam body, wherein the recess borders a first side of the resilient foam body and extends inwardly towards a second side of the resilient foam body which opposes the first side, with at least part of the recess having a depth which increases with distance from the first side of the resilient foam body.

2. A seat cushion according to claim 1, in which the recess has substantially no depth at the first side of the resilient foam body.

3. A seat cushion according to claim 1, in which the depth of the recess increases uniformly towards a region of maximum depth.

4. A seat cushion according to claim 3, in which the region of maximum depth is substantially adjacent the second side of the resilient foam body.

5. A seat cushion according to claim 1, further comprising a waterproof layer bonded to the resilient foam body.
